(19) United States
(12) Patent Application Publication
(10) Pub. No.: US 2025/0261010 A1
(43) Pub. Date: Aug. 14, 2025

(54) SYSTEMS, METHODS, AND DEVICES FOR INTERRUPTION REDUCTION DURING DEACTIVATED SECONDARY CELL GROUP

(71) Applicant: Apple Inc., Cupertino, CA (US)

(72) Inventors: Qiming Li, Beijing (CN); Yang Tang, San Jose, CA (US); Dawei Zhang, Saratoga, CA (US); Jie Cui, San Jose, CA (US); Manasa Raghavan, Sunnyvale, CA (US); Xiang Chen, Campbell, CA (US); Yushu Zhang, Beijing (CN)

(21) Appl. No.: 18/856,656

(22) PCT Filed: Apr. 22, 2022
(86) PCT No.: PCT/CN2022/088455

§ 371 Date: Oct. 14, 2024

(51) Int. Cl. H04W 24/08; H04L 5/00; H04L 27/26

(52) U.S. Cl. CPC H04W 24/08; H04L 5/0051; H04L 5/0098; H04L 27/2605

(57) ABSTRACT

Solutions are provided for enabling a user equipment (UE) to reduce measurements made on a deactivated primary secondary cell. In one example, a method includes processing a configuration of resources for a measurement timing window for measuring first reference signals for radio resource management and a configuration of resources for second reference signals for either radio link monitoring or beam failure detection. A first subset of the resources for the second reference signals are received within the measurement timing window and a second subset of the resources for the second reference signals are received outside the measurement timing window. When the SCG is deactivated, a status of an interruption alignment indicator is determined. When the interruption alignment indicator is set, the method includes refraining from measuring subsequent second reference signals transmitted in the second subset of the resources for the second reference signals.

### FIELD

This disclosure relates to wireless communication networks including techniques for conserving power within wireless communication networks.

### BACKGROUND

As the number of mobile devices within wireless networks, and the demand for mobile data traffic, continue to increase, changes are made to system requirements and architectures to better address current and anticipated demands. For example, some wireless communication networks may be developed to implement fifth generation (5G) or new radio (NR) technology, sixth generation (6G) technology, and so on. An aspect of such technology includes addressing how wireless devices manage power, which may include mobile power sources such as batteries, while remaining connected to the network.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example network according to one or more implementations described herein.

FIG. 2 is a diagram of a master cell group (MCG) and a secondary cell group (SCG) of a wireless communication network.

FIG. 3 is a diagram outlining examples of signals that may be exchanged by a user equipment and an access node during deactivation of an SCG according to one or more implementations described herein.

FIG. 4A is a diagram illustrating aligned reference signals that may be monitored by a UE when an SCG is activated SCG according to one or more implementations described herein.

FIG. 4B is a diagram illustrating aligned reference signals that may be monitored by a UE when an SCG is deactivated SCG according to one or more implementations described herein.

FIG. 5A is a diagram illustrating aligned reference signals that may be monitored by a UE when an SCG is deactivated and the UE is operating in frequency range 1 (FR1) according to one or more implementations described herein.

FIG. 5B is a diagram illustrating aligned reference signals that may be monitored by a UE when an SCG is deactivated and the UE is operating in frequency range 2 (FR2) according to one or more implementations described herein.

FIG. 6 is a diagram of an example of a process for monitoring aligned reference signals before and after deactivation of an SCG according to one or more implementations described herein.

FIG. 7 is a diagram of an example of a process for configuring aligned reference signals according to one or more implementations described herein.

FIG. 8 is a diagram of an example of components of a device according to one or more implementations described herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

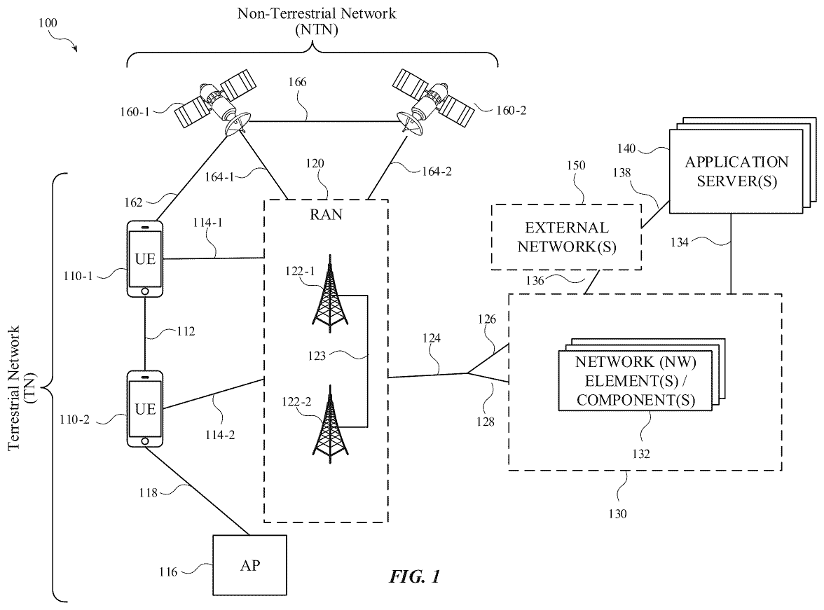

FIG. 1 is an example network 100 according to one or more implementations described herein. Example network 100 may include UEs 110-1, 110-2, etc. (referred to collectively as “UEs 110” and individually as “UE 110”), a radio access network (RAN) 120, a core network (CN) 130, application servers 140, external networks 150, and satellites 160-1, 160-2, etc. (referred to collectively as “satellites 160” and individually as “satellite 160”). As shown, network 100 may include a non-terrestrial network (NTN) comprising one or more satellites 160 (e.g., of a global navigation satellite system (GNSS)) in communication with UEs 110 and RAN 120.

The present disclosure relates to the monitoring of reference signals by a UE 110 from the RAN 120 for maintaining communication with multiple cells of the RAN 120. In some implementations, a base station (as described herein) may be an example of network node 122. RAN 120 may include one or more RAN nodes 122-1 and 122-2 (referred to collectively as RAN nodes 122, and individually as RAN node 122) that enable channels 114-1 and 114-2 to be established between UEs 110 and RAN 120. RAN nodes 122 may include network access points configured to provide radio baseband functions for data and/or voice connectivity between users and the network based on one or more of the communication technologies described herein (e.g., 2G, 3G, 4G, 5G, WiFi, etc.). UEs 110 may communicate and establish a connection with (e.g., be communicatively coupled) with RAN 120, which may involve one or more wireless channels 114-1 and 114-2, each of which may comprise a physical communications interface/layer.

In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 122-1 and 122-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The SN, acting as primary secondary cell (PSCell), configures reference signals to be used by the UE to monitor radio link quality and/or beam failure detection for a secondary cell group (SCG).

The MN and SN may be connected via a network interface, and at least the MN may be connected to the CN 130. Additionally, at least one of the MN or the SN may be operated with shared spectrum channel access, and functions specified for UE 110 can be used for an integrated access and backhaul mobile termination (IAB-MT). Similar for UE 101, the IAB-MT may access the network using either one network node or using two different nodes with enhanced dual connectivity (EN-DC) architectures, new radio dual connectivity (NR-DC) architectures, or the like. Such network access using two different nodes may be activated and deactivated depending on network conditions and downlink data traffic for the UE. Additional details of the network 100 will be described below.

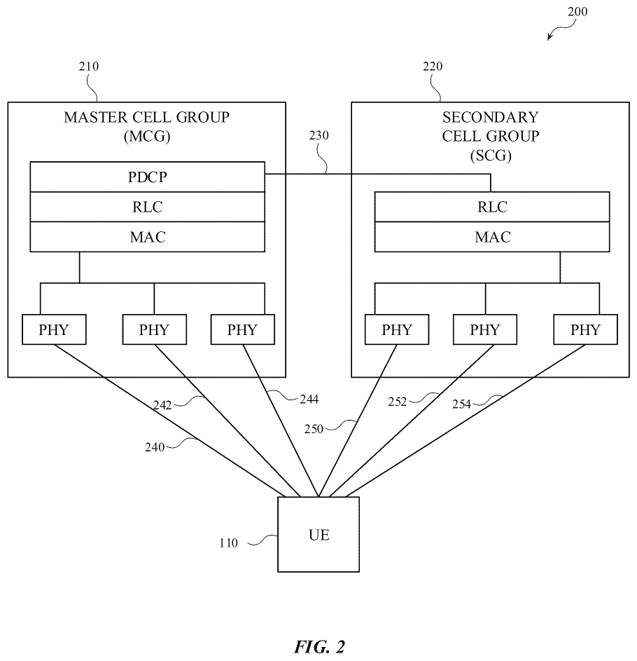

FIG. 2 is a diagram of an example 200 of a master cell group (MCG) 210 and a secondary cell group (SCG) 220 of a wireless communication network. An MCG may include a group of cells associated with a master node, comprising a primary cell (PCell) and one or more secondary cells (SCells). An SCG may include a group of serving cells associated with a secondary node, comprising a primary cell of the secondary cell group (PSCell) and optionally one or more secondary cells (SCells).

MCG 210 may be implemented by one or more base stations 122 and may include one or more layers. Examples of such layers may include a packet data convergence protocol (PDCP) layer, a radio link control (RLC) layer, a media access control (MAC) layer, and multiple physical (PHY) layers. Each PHY layer may correspond to a different implementation of a cell with respect to UE 110. Additionally, or alternatively, the PHY layers may operate in combination (e.g., be managed, controlled by, etc.) the PDCP, layer RLC, layer, and MAC layers. In some implementations, one PHY layer 240 may operate as a primary cell (PCell) or a special cell (SpCell) and other PHY layers 242 and 244 may operate to secondary cells (SCells) to the PCell.

SCG 220 may be implemented by one or more base stations 122 and may include multiple layers as well, including an RLC layer, a MAC layer, and multiple PHY layers. SCG 220 may not include a PDCP layer, but instead may rely on the PDCP layer of MCG 210 via connection 230. Similar to the PHY layers of MCG 210, the PHY layers of SCG 220 may each function or operate as a cell with respect to UE 110. In some implementations, one PHY layer 250 may operate as a primary cell (PCell) to PHY layers 252 and 254 operating as secondary cells to the PCell of PHY layer 250. As such, a special cell (SpCell) as described herein, may include a PCell of MCG 210 or a PCell of SCG 220. A scheduling secondary cell (sSCell), as described herein, may include a secondary cell (SCell) to any SpCell, which may each reside in the same cell group or different cell groups. Further, while FIG. 2 includes only 2 cell groups, implementation discussed herein may be applied to multiple cell groups operating in synchronization or collaboration with one another to perform the techniques described herein. Furthermore, each cell group (e.g., MCG and/or SCG) may be implemented on one or more base station, and a cell group operating as either an MCG or SCG may change, and cells within a cell group (e.g., a SpCell, SCell, sSCell, etc.) may be changed by activation, deactivation, dormancy, etc.

MCG 210 and SCG 220 may be involved in a dual connectivity scenario with UE 110, in which case a random access channel (RACH) procedure, and the like, may be directed to MCG 210. Additionally, MCG 210 may include a PCell (e.g., 240) and SCG 220 may include primary secondary cell PSCELL (e.g., 250), and a PCell or PSCell may be referred to herein as a special cell or special primary cell, represented as SpCell. Further, a secondary cell (SCell) of either MCG 210 or SCG 220 may operate as a scheduling secondary cell (sSCell) configured to provide configuration, scheduling, activation, deactivation, and other functions or commands toward a SpCell of either MCG 210 or SCG 220. As such, a base station, a baseband processor of a base station, etc., may include a base station of MCG 210 and/or SCG 220 controlling, managing, enabling, etc., a sSCell, of either MCG 210 and/or SCG 220, and/or a SpCell of either MCG 210 and/or SCG 220, which may include additional SCells or SpCells within either MCG 210 and/or SCG 220.

### Interruption Reduction Techniques

A UE measures reference signals (e.g., system synchronizations blocks (SSBs)) from neighboring cells for the purposes of radio resource management (RRM). The RRM process is configured to ensure channels, frequencies ranges, beams, and network infrastructure are used appropriately given the constraints of the overall system and capabilities of individual devices and changing needs or requirements of devices. RRM may include processes and algorithms for controlling transmission parameters and conditions between the UE and base station, such as transmit power, beamforming, data rates, handover criteria, modulation scheme, error coding scheme, etc. An example of RRM may include switching serving cells or activating/deactivating/changing SCGs or SCells for a UE. The UE is configured with a SSB/physical broadcast channel (PBCH) measurement timing configuration window SMTC by the network. During the SMTC window, the UE is able to measure SSBs from neighboring cells including active serving cells, deactivated SCells, PSCell, and other neighboring cells.

When a UE operates using dual connectivity (MR-DC), the UE may be configured to perform radio link monitoring (RLM) on an active downlink (DL) bandwidth part (BWP) of the PCell of the MCG and also on an active DL BWP of the PSCell of the SCG. The PCell and PSCell may be collectively referred to as a SpCell (Special Cell). RLM may include functions at the physical (PHY) layer, media access (MAC) layer, and radio resource control (RRC) layer. RLM at the physical layer may include monitoring DL radio link quality and sending measurement results to upper layers. RLM at the MAC layer may include beam failure detection (BFD) and recovery, RLM at the RRC layer may include configuring PHY and MAC layer, radio link failure detection and RRC-establishment (and RRC re-establishment).

RLM may be performed based on different RLM reference signal (RLM-RS) resources, which may be configured by a base station through RRC messaging (e.g., via the RadioLinkMonitoringConfig information element (IE) or RadioLinkMonitoringRS-Id). Examples of these resources may include SSBs, channel state information (CSI) resource signals (CSI-RSs), or a combination of SSBs and a CSI-RS. The rate with which reference signals (e.g., SSBs and a CSI-RS) are configured and transmitted by a base station and measured by a UE for RLM, BFD, etc., may be referred to as a periodicity.

BFD may be performed on different BFD reference signal (BFD-RS) resources, which may be configured by a base station through RRC messaging (e.g., via configuring of set q0, identification of CSI-RS resource indices for BFD, and so on) or determined implicitly by the UE based on active TCI states. In some instances, the RLM-RS resources and the BFD-RS resources are configured jointly in the same RRC message.

When a UE is connected to an activated SCG, the UE measures RRM-RS and, if configured, also RLM-RS and/or BFD-RS from the PSCell and SCells. To conserve UE power, when the amount of downlink data does not warrant use of the SCG, the SCG may be deactivated and the UE may switch off RF chains related to the SCG. When the SCG is deactivated, the UE no longer measures the BFD-RS from the SCells. However, the UE May continue to measure RRM-RS from the SCells and the PSCell as well as the RLM-RS and BFD-RS from the PSCell, if configured. Measuring the RRM-RS, RLM-RS, and BFD-RS on a deactivated SCG may cause interruptions on active serving cells in the MCG. This is because the UE turns the RF chain for the PSCell back on when necessary to make measurements, which may cause interruptions due to shared components with the RF chains associated with the MCG (e.g., power supplies). If this interruption becomes unacceptably long or frequent, a network may avoid configuring RLM/BFD for SCG and/or deactivating SCG due to the performance penalty, which could degrade the performance of the UE.

Techniques described herein provide solutions for enabling a UE connected to a deactivated SCG to reduce the number of measurement occasions for the PSCell RLM-RS and BFD-RS when an SCG is deactivated. This reduces the interruption to the MCG and increases the likelihood a network will configure RLM/BFD for SCG and deactivate an SCG to conserve UE power.

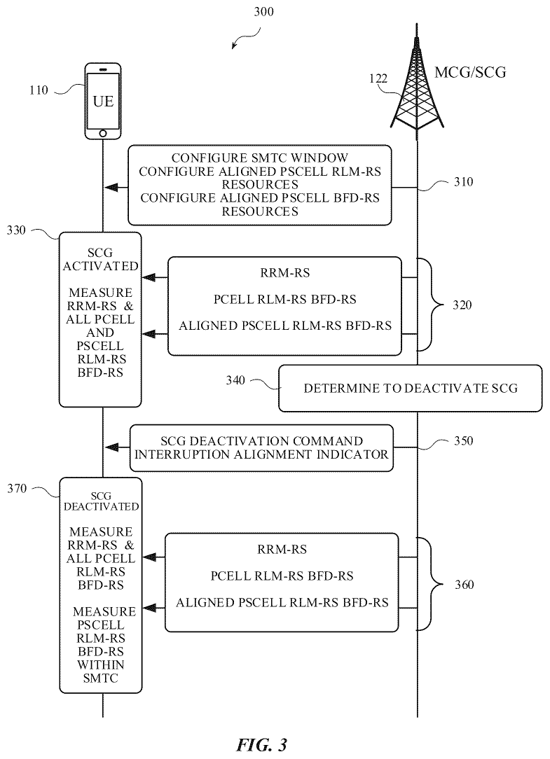

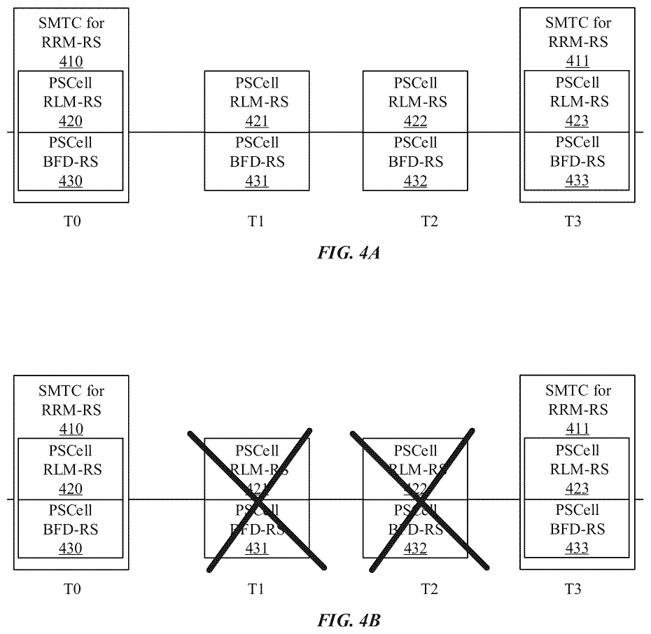

FIG. 3 is a signal flow diagram outlining one example of signals that may be exchanged between a UE 110 and a RAN node(s) 122 implementing an MCG/SCG. At 310 a measurement timing (e.g., SMTC) window is configured for the UE for use in RRM measurements. The measurement timing window may be configured by the PCell of the MCG or the PSCell of the SCG. At 310, RLM-RS resources and BFD-RS resources for the SCG are configured by the PSCell. The PSCell aligns the RLM-RS and BFD-RS with the measurement timing window. When RLM-RS and/or BFD-RS (or any other RS) are “aligned”, it means that at least some of the RS will be received by the UE during a configured measurement timing window. For example, when both RLM-RS and BFD-RS are transmitted by the PSCell, the PSCell configures the timing of the RLM-RS and BFD-RS so that a first subset of the RLM-RS and a first subset of the BFD-RS resources will be received by the UE during the configured measurement timing window while a second subset of the RLM-RS and a second subset of the BFD-RS will be received by the UE 110 outside the measurement timing window. While the examples of FIGS. 3 and 4 will be described in the context of both the RLM-RS and BFD-RS being aligned with the measurement timing window, in other examples only one of RLM-RS or BFD-RS may be aligned with the measurement timing window.

At 320 the MCG transmits RRM-RS, RLM-RS (if configured), and BFD-RS (if configured) and the SCG transmits RRM-RS and aligned RLM-RS (if configured) and aligned BFD-RS (if configured). At 330, when the SCG is activated, the UE measures the RRM-RS, RLM-RS, and BFD-RS from the MCG and the active SCG (which may include measuring of SCell and PSCell reference signals). When the SCG is activated, the UE measures RLM-RS and BFD-RS for the SCG that are received within the measurement timing window and also the RLM-RS and BFD-RS that are received outside the measurement timing window.

At 340, the MCG determines to deactivate the SCG and at 350, the MCG transmits an SCG deactivation command that includes an interruption alignment indicator. In some examples the interruption alignment indicator is part of the SCG deactivation command (e.g., is contained in a field or bit set of the SCG deactivation command). In one example, the interruption alignment indicator is a flag (e.g., an InterruptionAlignmentSCG flag in the SCG deactivation command). In other embodiments, the interruption alignment indicator may be transmitted at a different time (e.g., at SCG activation) or as part of a different command. The interruption alignment indicator being set or enabled informs the UE 110 that the PSCell's RLM-RS and BFD-RS are aligned with the measurement timing window. The SCG is subsequently deactivated.

At 360, just as at 320, the MCG transmits RRM-RS, RLM-RS (if configured), and BFD-RS (if configured) and the SCG transmits RRM-RS and aligned RLM-RS (if configured) and aligned BFD-RS (if configured). At 370, when the SCG is deactivated, the UE measures the RRM-RS, RLM-RS, and BFD-RS from the MCG and RLM-RS and BFD-RS for the SCG that are received within the measurement timing window. However, in response to the interruption alignment indicator being set, the UE refrains from measuring RLM-RS and BFD-RS that are received outside the measurement timing window. This reduces interruptions that are caused by measurements made outside the measurement timing window while allowing the UE to continue to make some measurements RLM-RS and BFD-RS of the PSCell of the deactivated SCG. In one example (not shown), the deactivated PSCell may cease transmission of RLM-RS and BFD-RS outside the measurement timing window to reduce signaling overhead and interference.

FIGS. 4A and 4B illustrate aligned reference signals that may be configured by a PSCell of an SCG to which the UE is connected. In the illustrated example, the RLM-RS and BFD-RS have the same offset and periodicity. The RLM-RS and BFD-RS periodicity is higher than the periodicity of the SMTC configured for RRM-RS measurements. Every third RLM-RS/BFD-RS will occur within an SMTC. Specifically, a first subset of RLM-RS 420, 423 and a first subset of BFD-RS 430, 433 coincide, in time, with an SMTC (410, 411, respectively) and will be received by the UE within the SMTCs. A second subset of RLM-RS 421, 422 and a second subset of BFD-RS 431, 432 do not coincide with the SMTCs and will be received by the UE outside the SMTCs.

FIG. 4A illustrates aligned reference signals that are measured by a UE when the SCG is activated, according to one example. At T0, the UE measures RRM-RS occurring within an SMTC window 410 as well as aligned PSCell RLM-RS 420 and BFD-RS 430, which are received during the SMTC window 410. At T1 and T2, the UE measures PSCell RLM-RS 421, 422 and BFD-RS 431, 432, respectively, which are received outside an SMTC window. At T3 the UE measures RRM-RS occurring within an SMTC window 411 and aligned PSCell RLM-RS 423 and BFD-RS 433, which are received during the SMTC window 411. It is noted that in FIGS. 4A and 4B, the RLM-RS and BFD-RS have the same periodicity. However, in other examples, the RLM-RS and BFD-RS do not have the same periodicity. As long as some of the RLM-RS and BFD-RS fall within the measurement timing window, then the interruption alignment technique may be used.

FIG. 4B illustrates aligned reference signals that are measured by a UE when the SCG is deactivated, according to one example. At T0, the UE measures RRM-RS occurring within an SMTC window 410. Aligned PSCell RLM-RS 420 and BFD-RS 430, which are received during the SMTC window 410, are also monitored by the UE at T0. At T1 and T2, the UE does not measure PSCell RLM-RS 421, 422 and BFD-RS 431, 432, respectively, which are received outside an SMTC window. At T03 the UE measures RRM-RS occurring within an SMTC window 411 as well as aligned PSCell RLM-RS 423 and BFD-RS 433, which are received during the SMTC window 411. Thus, when the SCG is deactivated, two monitoring/measuring occasions may be skipped by the UE, which will significantly reduce the interruption of the RF chain(s) processing signals from the MCG.

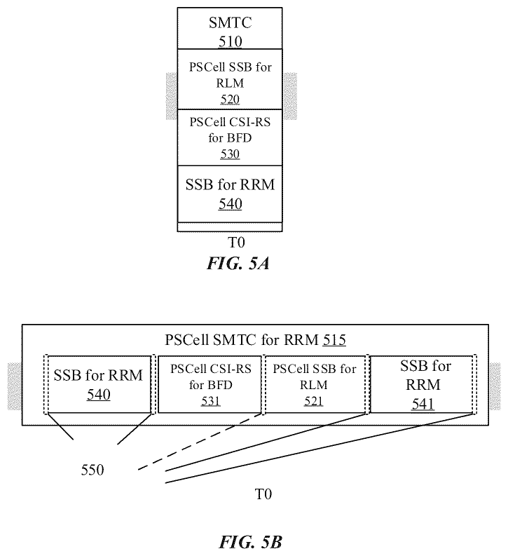

FIGS. 5A and 5B illustrate examples of how aligned reference signals may be configured in terms of timing within an SMTC based on whether the reference signals are FR1 or FR2. In the examples of FIGS. 5A and 5B, the RLM-RS are SSBs and the BFD-RS are CSI-RS. It is to be understood that other reference signals may be used for RLM-RS and BFD-RS and that reference signals for other purposes may also be aligned so that some of the reference signals occur within an SMTC.

When the UE is operating in frequency range 1 (FR1), the UE can measure RLM-RS, BFD-RS, and RRM-RS simultaneously. In this case, as illustrated in FIG. 5A, resources for PSCell SSB for RLM 520 and resources for PSCell CSI-RS for BFD 530 may overlap in time, either partially or completely, with each other, and with the resources for RRM-RS 540 (e.g., SSBs from neighboring cells) within the SMTC window 510. The interruption caused to the RF chains handling the MSG by the PSCell RLM and BFD measurements is shown by the shaded box on either side the SMTC window 510.

When the UE is operating in frequency range 2 (FR2) the UE may not be able measure RLM-RS, BFD-RS, and RRM-RS simultaneously because different receive beams may be required. In this case, as illustrated in FIG. 5B, resources for PSCell SSB for RLM 520 and resources for PSCell CSI-RS for BFD 530 may not overlap, either partially or completely, with the resources for RRM-RS 540. A guard period 550 is used before and after the RRM-RS resources 540, 541 and the RLM-RS 521 and BFD-RS 531 to allow for beam switching. The guard period may be, for example, one data symbol. If the RLM-RS and BFD-RS share a transmission configuration indicator (TCI) chain, the resources for the BFD-RS and RLM-RS may overlap with each other either partially or completely. If, however, different receive beams are used for the RLM-RS and BFD-RS, then, as shown in FIG. 5B, the resources for the RLM-RS and BFD-RS cannot overlap and a guard period is used between the resources for the RLM-RS and BFD-RS to allow for beam switching. The interruption caused to the RF chains handling the MSG by the PSCell RLM and BFD measurements is shown by the shaded box on either side the SMTC window 515.

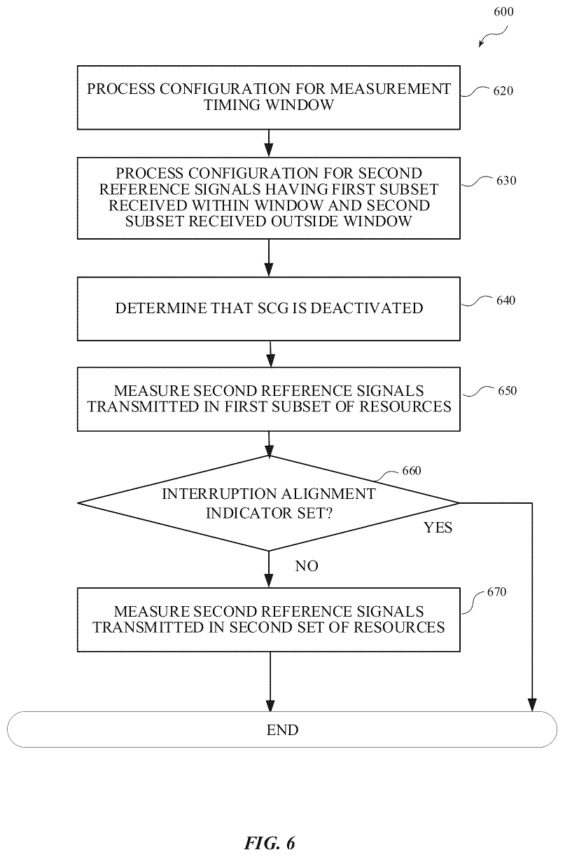

FIG. 6 is a flow diagram outlining an example method 600 that may be performed by a UE to monitor/measure reference signals from an SCG when the SCG is activated and when the SCG is deactivated. At 620 the UE processes a configuration of resources for a measurement timing window for measuring first reference signals for radio resource management (RRM). At 630, the UE processes a configuration of resources for second reference signals for either radio link monitoring (RLM) or beam failure detection (BFD). A first subset of the resources for the second reference signals is received by the UE within the measurement timing window and a second subset of the resources for the second reference signals is received outside the measurement timing window.

At 640, it is determined that the SCG is deactivated, at 650 the UE measures second reference signals transmitted in the first subset of the resources for the second reference signals. At 660, the UE determines the status of an interruption alignment indicator. When the interruption alignment indicator is not set, at 670 the UE measures second reference signals transmitted in the second subset of the resources for the second reference signals (e.g., second reference signals occurring outside the measurement timing window). When the interruption alignment indicator is set, the UE refrains from measuring the second reference signals transmitted in the second subset of the resources for the second reference signals.

The phrase “interruption indicator is set” means broadly that the UE has received an indication in some manner that the references signals from the SCG are aligned with the measurement timing windows. In one example, the interruption alignment indicator is an InterruptionAlignmentSCG flag in the SCG deactivation command.

In one example, as shown in FIG. 5A, the first reference signal and the second reference signal(s) in each measurement timing window overlap in time. In one example, as shown in FIG. 5B, the first reference signal and the second reference signal(s) in each measurement timing window are non-overlapping in time. In one example, the non-overlapping first reference signal and second reference signal(s) are separated by a guard period within the measurement timing window. In some examples, the second reference signals include reference signals used for either RLM or BFD. In other examples, the second reference signals include reference signals used for RLM and other reference signals used for BFD.

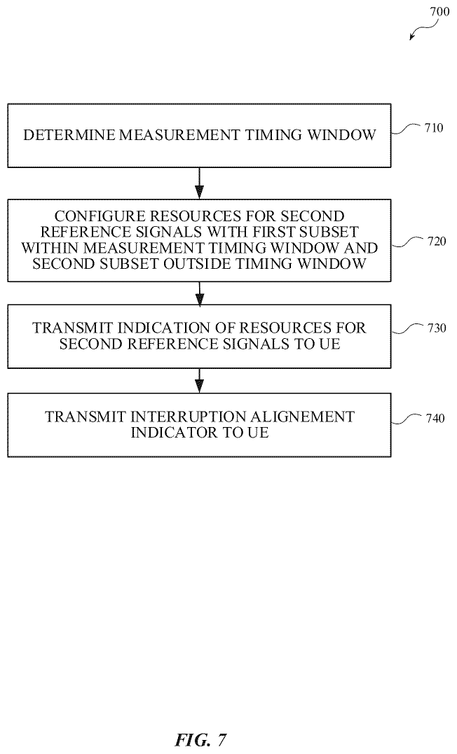

FIG. 7 is a flow diagram of an example method 700 that may be performed by a RAN node acting as PSCell of an activated SCG connected to a UE. At 710 the PSCell determines a measurement timing window during which a UE measures first reference signals for radio resource management (RRM). At 720 the PSCell configures resources for second reference signals. A first subset of the second reference signal resources are within the measurement timing window (e.g., will be received by the UE within the window) and a second subset of the second reference signal resources are outside the measurement timing window (e.g., will be received by the UE outside the window). The second reference signals are transmitted by the PSCell for radio link monitoring (RLM) and/or beam failure detection (BFD).

At 730 the PSCell transmits an indication of the resources for the second reference signal to the UE. At 740, the PSCell transmits an interruption alignment indicator to the UE that indicates to the UE that the resources for the first subset of the second reference signals will be received within the measurement timing window.

In one example, the PSCell configures the measurement timing window and transmits transmit an indication of the measurement timing window to the UE while in other examples, the measurement timing window is configured by the PCell of an MCG for the UE.

As can be seen from the foregoing description, when the PSCell aligns RLM-RS and/or BFD-RS with an SMTC of a UE, the UE may skip monitoring of RLM-RS and/or BFD-RS that do not occur within the SMTC when the SCG is deactivated. This reduces the interruption caused by measuring of a deactivated PSCell and increases the benefit of deactivating an SCG.

In one example, if the interruption alignment indicator is set or enabled, interruptions may be limited as follows. Interruptions on the PCell or activated SCells due to RRM measurements on the deactivated PSCell are allowed with up to 0.5% probability of missed AC/NACK feedback. If the UE is configured with RRM measurements on the deactivated PSCell, no additional interruptions on the PCell or activated SCell(s) due to RLM/BFD measurements on the activated PSCell are allowed.

### Wireless Network and Device

Returning to FIG. 1, additional details of the wireless network 100 are here described. The systems and devices of example network 100 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 100 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 110 may include smartphones (e.g., handheld touchscreen mobile computing devices connectable to one or more wireless communication networks). Additionally, or alternatively, UEs 110 may include other types of mobile or non-mobile computing devices capable of wireless communications, such as personal data assistants (PDAs), pagers, laptop computers, desktop computers, wireless handsets, etc. In some implementations, UEs 110 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

A RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 122 may include a roadside unit (RSU), a transmission reception point (TRxP or TRP), and one or more other types of ground stations (e.g., terrestrial access points). In some scenarios, RAN node 122 may be a dedicated physical device, such as a macrocell base station, and/or a low power (LP) base station for providing femtocells, picocells or the like having smaller coverage areas, smaller user capacity, or higher bandwidth compared to macrocells. Satellites 160 may operate as bases stations (e.g., RAN nodes 122) with respect to UEs 110. As such, references herein to a base station, RAN node 122, etc., may involve implementations where the base station, RAN node 122, etc., is a terrestrial network node and also to implementation where the base station, RAN node 122, etc., is a non-terrestrial network node (e.g., satellite 160).

Some or all of RAN nodes 122, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 122; a media access control (MAC)/physical (PHY) layer split wherein RRC, PDCP, radio link control (RLC), and MAC layers may be operated by the CRAN/vBBUP and the PHY layer may be operated by individual RAN nodes 122; or a “lower PHY” split wherein RRC, PDCP, RLC, MAC layers and upper portions of the PHY layer may be operated by the CRAN/vBBUP and lower portions of the PHY layer may be operated by individual RAN nodes 122. This virtualized framework may allow freed-up processor cores of RAN nodes 122 to perform or execute other virtualized applications.

In some implementations, an individual RAN node 122 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server (not shown) located in RAN 120 or by a server pool (e.g., a group of servers configured to share resources) in a similar manner as the CRAN/vBBUP. Additionally, or alternatively, one or more of RAN nodes 122 may be next generation eNBs (i.e., gNBs) that may provide evolved universal terrestrial radio access (E-UTRA) user plane and control plane protocol terminations toward UEs 110, and that may be connected to a 5G core network (5GC) 130 via an NG interface.

Any of the RAN nodes 122 may terminate an air interface protocol and may be the first point of contact for UEs 110. In some implementations, any of the RAN nodes 122 may fulfill various logical functions for the RAN 120 including, but not limited to, radio network controller (RNC) functions such as radio bearer management, uplink and downlink dynamic radio resource management and data packet scheduling, and mobility management. UEs 110 may be configured to communicate using orthogonal frequency-division multiplexing (OFDM) communication signals with each other or with any of the RAN nodes 122 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

As shown, UE 110 may also, or alternatively, connect to access point (AP) 116 via connection interface 118, which may include an air interface enabling UE 110 to communicatively couple with AP 116. AP 116 may comprise a wireless local area network (WLAN), WLAN node, WLAN termination point, etc. The connection 1207 may comprise a local wireless connection, such as a connection consistent with any IEEE 702.11 protocol, and AP 116 may comprise a wireless fidelity (Wi-Fi®) router or other AP. While not explicitly depicted in FIG. 1, AP 116 may be connected to another network (e.g., the Internet) without connecting to RAN 120 or CN 130. In some scenarios, UE 110, RAN 120, and AP 116 may be configured to utilize LTE-WLAN aggregation (LWA) techniques or LTE WLAN radio level integration with IPsec tunnel (LWIP) techniques. LWA may involve UE 110 in RRC_CONNECTED being configured by RAN 120 to utilize radio resources of LTE and WLAN. LWIP may involve UE 110 using WLAN radio resources (e.g., connection interface 118) via IPsec protocol tunneling to authenticate and encrypt packets (e.g., Internet Protocol (IP) packets) communicated via connection interface 118. IPsec tunneling may include encapsulating the entirety of original IP packets and adding a new packet header, thereby protecting the original header of the IP packets.

In some implementations, a downlink resource grid may be used for downlink transmissions from any of the RAN nodes 122 to UEs 110, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 122 may be configured to wirelessly communicate with UEs 110, and/or one another, over a licensed medium (also referred to as the “licensed spectrum” and/or the “licensed band”), an unlicensed shared medium (also referred to as the “unlicensed spectrum” and/or the “unlicensed band”), or combination thereof. In an example, a licensed spectrum may include channels that operate in the frequency range of approximately 400 MHz to approximately 3.8 GHz, whereas the unlicensed spectrum may include the 5 GHz band. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 110 and the RAN nodes 122 may operate using NR unlicensed, licensed assisted access (LAA), eLAA, and/or feLAA mechanisms. In these implementations, UEs 110 and the RAN nodes 122 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The LAA mechanisms may be built upon carrier aggregation (CA) technologies of LTE-Advanced systems. In CA, each aggregated carrier is referred to as a component carrier (CC). In some cases, individual CCs may have a different bandwidth than other CCs. In time division duplex (TDD) systems, the number of CCs as well as the bandwidths of each CC may be the same for DL and UL. CA also comprises individual serving cells to provide individual CCs. The coverage of the serving cells may differ, for example, because CCs on different frequency bands will experience different pathloss. A primary service cell or PCell may provide a primary component carrier (PCC) for both UL and DL and may handle RRC and non-access stratum (NAS) related activities. The other serving cells are referred to as SCells, and each SCell may provide an individual secondary component carrier (SCC) for both UL and DL. The SCCs may be added and removed as required, while changing the PCC may require UE 110 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different PUSCH starting positions within a same subframe. To operate in the unlicensed spectrum, UEs 110 and the RAN nodes 122 may also operate using stand-alone unlicensed operation where the UE may be configured with a PCell, in addition to any SCells, in unlicensed spectrum.

The PDSCH may carry user data and higher layer signaling to UEs 110. The physical downlink control channel (PDCCH) may carry information about the transport format and resource allocations related to the PDSCH channel, among other things. The PDCCH may also inform UEs 110 about the transport format, resource allocation, and hybrid automatic repeat request (HARQ) information related to the uplink shared channel. Typically, downlink scheduling (e.g., assigning control and shared channel resource blocks to UE 110-2 within a cell) may be performed at any of the RAN nodes 122 based on channel quality information fed back from any of UEs 110. The downlink resource assignment information may be sent on the PDCCH used for (e.g., assigned to) each of UEs 110.

The PDCCH uses control channel elements (CCEs) to convey the control information, wherein a number of CCEs (e.g., 6 or the like) may consists of a resource element groups (REGs), where a REG is defined as a physical resource block (PRB) in an OFDM symbol. Before being mapped to resource elements, the PDCCH complex-valued symbols may first be organized into quadruplets, which may then be permuted using a sub-block interleaver for rate matching, for example. Each PDCCH may be transmitted using one or more of these CCEs, where each CCE may correspond to nine sets of four physical resource elements known as REGs. Four quadrature phase shift keying (QPSK) symbols may be mapped to each REG. The PDCCH may be transmitted using one or more CCEs, depending on the size of the DCI and the channel condition. There may be four or more different PDCCH formats defined in LTE with different numbers of CCEs (e.g., aggregation level, L=1, 2, 4, 8, or 16).

Some implementations may use concepts for resource allocation for control channel information that are an extension of the above-described concepts. For example, some implementations may utilize an extended (E)-PDCCH that uses PDSCH resources for control information transmission. The EPDCCH may be transmitted using one or more ECCEs. Similar to the above, each ECCE may correspond to nine sets of four physical resource elements known as an EREGs. An ECCE may have other numbers of EREGs in some situations.

The RAN nodes 122 may be configured to communicate with one another via interface 123. In implementations where the system is an LTE system, interface 123 may be an X2 interface. In NR systems, interface 123 may be an Xn interface. The X2 interface may be defined between two or more RAN nodes 122 (e.g., two or more eNBs/gNBs or a combination thereof) that connect to evolved packet core (EPC) or CN 130, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 110 from an SeNB for user data; information of PDCP PDUs that were not delivered to a UE 110; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 120 may be connected (e.g., communicatively coupled) to CN 130. CN 130 may comprise a plurality of network elements 132, which are configured to offer various data and telecommunications services to customers/subscribers (e.g., users of UEs 110) who are connected to the CN 130 via the RAN 120. In some implementations, CN 130 may include an evolved packet core (EPC), a 5G CN, and/or one or more additional or alternative types of CNs. The components of the CN 130 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 130 may be referred to as a network slice, and a logical instantiation of a portion of the CN 130 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 130, application servers 140, and external networks 150 may be connected to one another via interfaces 134, 136, and 138, which may include IP network interfaces. Application servers 140 may include one or more server devices or network elements (e.g., virtual network functions (VNFs) offering applications that use IP bearer resources with CN 130 (e.g., universal mobile telecommunications system packet services (UMTS PS) domain, LTE PS data services, etc.). Application servers 140 may also, or alternatively, be configured to support one or more communication services (e.g., voice over IP (VOIP sessions, push-to-talk (PTT) sessions, group communication sessions, social networking services, etc.) for UEs 110 via the CN 130. Similarly, external networks 150 may include one or more of a variety of networks, including the Internet, thereby providing the mobile communication network and UEs 110 of the network access to a variety of additional services, information, interconnectivity, and other network features.

As shown, example network 100 may include an NTN that may comprise one or more satellites 160-1 and 160-2 (collectively, “satellites 160”). Satellites 160 may be in communication with UEs 110 via service link or wireless interface 162 and/or RAN 120 via feeder links or wireless interfaces 164 (depicted individually as 164-1 and 164). In some implementations, satellite 160 may operate as a passive or transparent network relay node regarding communications between UE 110 and the terrestrial network (e.g., RAN 120). In some implementations, satellite 160 may operate as an active or regenerative network node such that satellite 160 may operate as a base station to UEs 110 (e.g., as a gNB of RAN 120) regarding communications between UE 110 and RAN 120. In some implementations, satellites 160 may communicate with one another via a direct wireless interface (e.g., 166) or an indirect wireless interface (e.g., via RAN 120 using interfaces 164-1 and 164-2).

Additionally, or alternatively, satellite 160 may include a GEO satellite, LEO satellite, or another type of satellite. Satellite 160 may also, or alternatively pertain to one or more satellite systems or architectures, such as a global navigation satellite system (GNSS), global positioning system (GPS), global navigation satellite system (GLONASS), BeiDou navigation satellite system (BDS), etc. In some implementations, satellites 160 may operate as bases stations (e.g., RAN nodes 122) with respect to UEs 110. As such, references herein to a base station, RAN node 122, etc., may involve implementations where the base station, RAN node 122, etc., is a terrestrial network node and implementation, where the base station, RAN node 122, etc., is a non-terrestrial network node (e.g., satellite 160). As described herein, UE 110 and base station 122 may communicate with one another, via interface 114, to enable enhanced power saving techniques.

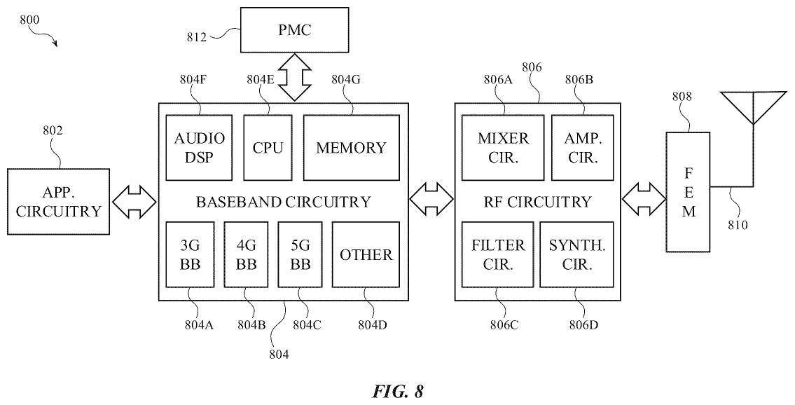

FIG. 8 is a diagram of an example of components of a device according to one or more implementations described herein. The components of the illustrated device 800 can be included in a UE or a RAN node that implements a PSCell of an SCG for the UE. In some implementations, the device 800 can include application circuitry 802, baseband circuitry 804, RF circuitry 806, front-end module (FEM) circuitry 808, one or more antennas 810, and power management circuitry (PMC) 812 coupled together at least as shown. In some implementations, the device 800 can include fewer elements (e.g., a RAN node may not utilize application circuitry 802, and instead include a processor/controller to process IP data received from a CN such as 5GC 130 or an Evolved Packet Core (EPC)). In some implementations, the device 800 can include additional elements such as, for example, memory/storage, display, camera, sensor (including one or more temperature sensors, such as a single temperature sensor, a plurality of temperature sensors at different locations in device 800, etc.), or input/output (I/O) interface. In other implementations, the components described below can be included in more than one device (e.g., said circuitries can be separately included in more than one device for Cloud-RAN (C-RAN) implementations).

The application circuitry 802 can include one or more application processors. For example, the application circuitry 802 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 800. In some implementations, processors of application circuitry 802 can process IP data packets received from an EPC.

The baseband circuitry 804 can include circuitry such as, but not limited to, one or more single-core or multi-core processors. The baseband circuitry 804 can include one or more baseband processors or control logic to process baseband signals (e.g., received RRM-RS, RLM-RS, and/or BFD-RS when the device is associated with a UE) received from a receive signal path of the RF circuitry 806 and to generate signals (e.g., RRM-RS, RLM-RS, and/or BFD-RS when the device is associated with a RAN node) for a transmit signal path of the RF circuitry 806. Baseband circuitry 804 can interface with the application circuitry 802 for generation and processing of the baseband signals and for controlling operations of the RF circuitry 806. For example, in some implementations, the baseband circuitry 804 can include a 3G baseband processor 804A, a 4G baseband processor 804B, a 5G baseband processor 804C, or other baseband processor(s) 804D for other existing generations, generations in development or to be developed in the future (e.g., 2G, 6G, etc.). The baseband circuitry 804 (e.g., one or more of baseband processors 804A-D) can handle various radio control functions that enable communication with one or more radio networks via the RF circuitry 806. In other implementations, some or all of the functionality of baseband processors 804A-D can be included in modules stored in the memory 804G and executed via a Central Processing Unit (CPU) 804E. The radio control functions can include, but are not limited to, signal modulation/demodulation, encoding/decoding, radio frequency shifting, etc. In some implementations, modulation/demodulation circuitry of the baseband circuitry 804 can include Fast-Fourier Transform (FFT), precoding, or constellation mapping/de-mapping functionality. In some implementations, encoding/decoding circuitry of the baseband circuitry 804 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, the baseband circuitry 804 can include one or more audio digital signal processor(s) (DSP) 804F. The audio DSPs 804F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 804 and the application circuitry 802 can be implemented together such as, for example, on a system on a chip (SOC).

In some implementations, the baseband circuitry 804 can provide for communication compatible with one or more radio technologies. For example, in some implementations, the baseband circuitry 804 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 804 is configured to support radio communications of more than one wireless protocol can be referred to as multi-mode baseband circuitry.

RF circuitry 806 can enable communication with wireless networks using modulated electromagnetic radiation through a non-solid medium. In various implementations, the RF circuitry 806 can include switches, filters, amplifiers, etc. to facilitate the communication with the wireless network. RF circuitry 806 can include a receive signal path which can include circuitry to down-convert RF signals received from the FEM circuitry 808 and provide baseband signals to the baseband circuitry 804. RF circuitry 806 can also include a transmit signal path which can include circuitry to up-convert baseband signals provided by the baseband circuitry 804 and provide RF output signals to the FEM circuitry 808 for transmission.

In some implementations, the receive signal path of the RF circuitry 806 can include mixer circuitry 806A, amplifier circuitry 806B and filter circuitry 806C. In some implementations, the transmit signal path of the RF circuitry 806 can include filter circuitry 806C and mixer circuitry 806A. RF circuitry 806 can also include synthesizer circuitry 806D for synthesizing a frequency for use by the mixer circuitry 806A of the receive signal path and the transmit signal path. In some implementations, the mixer circuitry 806A of the receive signal path can be configured to down-convert RF signals received from the FEM circuitry 808 based on the synthesized frequency provided by synthesizer circuitry 806D. The amplifier circuitry 806B can be configured to amplify the down-converted signals and the filter circuitry 806C can be a low-pass filter (LPF) or band-pass filter (BPF) configured to remove unwanted signals from the down-converted signals to generate output baseband signals. Output baseband signals can be provided to the baseband circuitry 804 for further processing. In some implementations, the output baseband signals can be zero-frequency baseband signals, although this is not a requirement. In some implementations, mixer circuitry 806A of the receive signal path can comprise passive mixers, although the scope of the implementations is not limited in this respect.

In some implementations, the mixer circuitry 806A of the transmit signal path can be configured to up-convert input baseband signals based on the synthesized frequency provided by the synthesizer circuitry 806D to generate RF output signals for the FEM circuitry 808. The baseband signals can be provided by the baseband circuitry 804 and can be filtered by filter circuitry 806C.

In some implementations, the mixer circuitry 806A of the receive signal path and the mixer circuitry 806A of the transmit signal path can include two or more mixers and can be arranged for quadrature down conversion and up conversion, respectively. In some implementations, the mixer circuitry 806A of the receive signal path and the mixer circuitry 806A of the transmit signal path can include two or more mixers and can be arranged for image rejection (e.g., Hartley image rejection). In some implementations, the mixer circuitry 806A of the receive signal path and the mixer circuitry 806A can be arranged for direct down conversion and direct up conversion, respectively. In some implementations, the mixer circuitry 806A of the receive signal path and the mixer circuitry 806A of the transmit signal path can be configured for super-heterodyne operation.

In some implementations, the output baseband signals and the input baseband signals can be analog baseband signals, although the scope of the implementations is not limited in this respect. In some alternate implementations, the output baseband signals and the input baseband signals can be digital baseband signals. In these alternate implementations, the RF circuitry 806 can include analog-to-digital converter (ADC) and digital-to-analog converter (DAC) circuitry and the baseband circuitry 804 can include a digital baseband interface to communicate with the RF circuitry 806.

In some dual-mode implementations, a separate radio IC circuitry can be provided for processing signals for each spectrum, although the scope of the implementations is not limited in this respect.

In some implementations, the synthesizer circuitry 806D can be a fractional-N synthesizer or a fractional N/N+1 synthesizer, although the scope of the implementations is not limited in this respect as other types of frequency synthesizers can be suitable. For example, synthesizer circuitry 806D can be a delta-sigma synthesizer, a frequency multiplier, or a synthesizer comprising a phase-locked loop with a frequency divider.

The synthesizer circuitry 806D can be configured to synthesize an output frequency for use by the mixer circuitry 806A of the RF circuitry 806 based on a frequency input and a divider control input. In some implementations, the synthesizer circuitry 806D can be a fractional N/N+1 synthesizer.

In some implementations, frequency input can be provided by a voltage controlled oscillator (VCO), although that is not a requirement. Divider control input can be provided by either the baseband circuitry 804 or the applications circuitry 802 depending on the desired output frequency. In some implementations, a divider control input (e.g., N) can be determined from a look-up table based on a channel indicated by the applications circuitry 802.

Synthesizer circuitry 806D of the RF circuitry 806 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 806D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 806 can include an IQ/polar converter.

FEM circuitry 808 can include a receive signal path which can include circuitry configured to operate on RF signals received from one or more antennas 810, amplify the received signals and provide the amplified versions of the received signals to the RF circuitry 806 for further processing. FEM circuitry 808 can also include a transmit signal path which can include circuitry configured to amplify signals for transmission provided by the RF circuitry 806 for transmission by one or more of the one or more antennas 810. In various implementations, the amplification through the transmit or receive signal paths can be done solely in the RF circuitry 806, solely in the FEM circuitry 808, or in both the RF circuitry 806 and the FEM circuitry 808.

In some implementations, the FEM circuitry 808 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 806). The transmit signal path of the FEM circuitry 808 can include a power amplifier (PA) to amplify input RF signals (e.g., provided by RF circuitry 806), and one or more filters to generate RF signals for subsequent transmission (e.g., by one or more of the one or more antennas 810).

In some implementations, the PMC 812 can manage power provided to the baseband circuitry 804. In particular, the PMC 812 can control power-source selection, voltage scaling, battery charging, or DC-to-DC conversion. The PMC 812 can often be included when the device 800 is capable of being powered by a battery, for example, when the device is included in a UE. The PMC 812 can increase the power conversion efficiency while providing desirable implementation size and heat dissipation characteristics.

While FIG. 8 shows the PMC 812 coupled only with the baseband circuitry 804. However, in other implementations, the PMC 812 may be additionally or alternatively coupled with, and perform similar power management operations for, other components such as, but not limited to, application circuitry 802, RF circuitry 806, or FEM circuitry 808.

In some implementations, the PMC 812 can control, or otherwise be part of, various power saving mechanisms of the device 800. For example, if the device 800 is in an RRC_Connected state, where it is still connected to the RAN node as it expects to receive traffic shortly, then it can enter a state known as Discontinuous Reception Mode (DRX) after a period of inactivity. During this state, the device 800 can power down for brief intervals of time and thus save power.

If there is no data traffic activity for an extended period of time, then the device 800 can transition off to an RRC_Idle state, where it disconnects from the network and does not perform operations such as channel quality feedback, handover, etc. The device 800 goes into a very low power state and it performs paging where again it periodically wakes up to listen to the network and then powers down again. The device 800 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 802 and processors of the baseband circuitry 804 can be used to execute elements of one or more instances of a protocol stack. For example, processors of the baseband circuitry 804, alone or in combination, can be used execute Layer 3, Layer 2, or Layer 1 functionality, while processors of the baseband circuitry 804 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

Above are several flow diagrams outlining example methods. In this description and the appended claims, use of the term “determine” with reference to some entity (e.g., parameter, variable, and so on) in describing a method step or function is to be construed broadly. For example, “determine” is to be construed to encompass, for example, receiving and parsing a communication that encodes the entity or a value of an entity. “Determine” should be construed to encompass accessing and reading memory (e.g., lookup table, register, device memory, remote memory, and so on) that stores the entity or value for the entity. “Determine” should be construed to encompass computing or deriving the entity or value of the entity based on other quantities or entities. “Determine” should be construed to encompass any manner of deducing or identifying an entity or value of the entity.

As used herein, the term identify when used with reference to some entity or value of an entity is to be construed broadly as encompassing any manner of determining the entity or value of the entity. For example, the term identify is to be construed to encompass, for example, receiving and parsing a communication that encodes the entity or a value of the entity. The term identify should be construed to encompass accessing and reading memory (e.g., device queue, lookup table, register, device memory, remote memory, and so on) that stores the entity or value for the entity.

As used herein, the term indicate is to be construed broadly as identifying an item, value, or quantity, to another communication device. For example, indicate may mean communicating a selection of one option among a set of options, or setting a flag or bit value in a field of a communicated signal (e.g., DCI, UCI).

### EXAMPLES

Example 1 is a baseband processor of a user equipment (UE), including one or more processors configured to process a configuration of resources for a measurement timing window for measuring first reference signals for radio resource management (RRM) and a configuration of resources for second reference signals for either radio link monitoring (RLM) or beam failure detection (BFD). A first subset of the resources for the second reference signals are received within the measurement timing window and a second subset of the resources for the second reference signals are received outside the measurement timing window. The second reference signals are transmitted by a primary secondary cell (PSCell) of a secondary cell group (SCG). The one or more processors are configured to determine that the SCG is deactivated, and in response determine a status of an interruption alignment indicator; and in response to the interruption alignment indicator being set, measure subsequent second reference signals transmitted in the first subset of the resources for the second reference signals, and refrain from measuring subsequent second reference signals transmitted in the second subset of the resources for the second reference signals.

Example 2 includes the subject matter of example 1, including or omitting optional elements, wherein the interruption alignment indicator includes an InterruptionAlignmentSCG flag in an SCG deactivation command.

Example 3 includes the subject matter of example 1, including or omitting optional elements, wherein a first reference signal and a second reference signal in each measurement timing window overlap in time.

Example 4 includes the subject matter of example 1, including or omitting optional elements, wherein a first reference signal and a second reference signal in each measurement timing window are non-overlapping in time.

Example 5 includes the subject matter of example 4, including or omitting optional elements, wherein the first reference signal and the second reference signal are separated by a guard period.

Example 6 includes the subject matter of example 1, including or omitting optional elements, wherein the second reference signals are for RLM and wherein the one or more processors are configured to process a configuration of resources for third reference signals for beam failure detection (BFD). A first subset of the resources for the third reference signals are received within the measurement timing window and a second subset of the resources for the third reference signals are received outside the measurement timing window. The third reference signals are transmitted the PSCell. The one or more processors are configured to determine that the SCG is deactivated, and in response determine a status of an interruption alignment indicator. In response to the interruption alignment indicator being set, the one or more processors are configured to measure subsequent third reference signals transmitted in the first subset of the resources for the third reference signals, and refrain from measuring subsequent third reference signals transmitted in the second subset of the resources for the third reference signals.

Example 7 includes the subject matter of example 6, including or omitting optional elements, wherein a second reference signal and a third reference signal in each measurement timing window overlap in time.

Example 8 includes the subject matter of example 6, including or omitting optional elements, wherein a second reference signal and a third reference signal in each measurement timing window are non-overlapping in time.

Example 9 includes the subject matter of example 8, including or omitting optional elements, wherein the first reference signal, the second reference signal, and the third reference signal are separated by a guard period.

Example 10 is a processor of a radio access node (RAN) configured to transmit and receive signals as a primary secondary cell (PSCell) for secondary cell group (SCG), including one or more processors configured to determine a measurement timing window during which a user equipment (UE) measures first reference signals for radio resource management (RRM); configure resources for second reference signals, wherein a first subset of the second reference signal resources are received by the UE within the measurement timing window and a second subset of the second reference signal will be received by the UE outside the measurement timing window, wherein the second reference signals are transmitted by the PSCell to the UE for radio link monitoring (RLM) or beam failure detection (BFD); transmit an indication of the resources for the second reference signals to the UE; and transmit an interruption alignment indicator to the UE that indicates to the UE that the resources for the first subset of the second reference signals are aligned with the measurement timing window.

Example 11 includes the subject matter of example 10, including or omitting optional elements, wherein the one or more processors are configured to configure the measurement timing window; and transmit an indication of the measurement timing window to the UE.

Example 12 includes the subject matter of example 10, including or omitting optional elements, wherein the interruption alignment indicator includes an InterruptionAlignmentSCG flag in an SCG deactivation command.

Example 13 includes the subject matter of example 10, including or omitting optional elements, wherein the first reference signal and the second reference signal in each measurement timing window overlap in time.

Example 14 includes the subject matter of example 10, including or omitting optional elements, wherein the first reference signal and the second reference signal in each measurement timing window are non-overlapping in time.

Example 15 includes the subject matter of example 14, including or omitting optional elements, wherein the first reference signal and the second reference signal are separated by a guard period.

Example 16 includes the subject matter of example 10, including or omitting optional elements, wherein the second reference signals are for RLM and wherein the one or more processors are configured to configure resources for third reference signals, wherein a first subset of the third reference signal resources are received by the UE within the measurement timing window and a second subset of the third reference signal resources are received by the UE outside the measurement timing window, wherein the third reference signals are transmitted by the PSCell for beam failure detection (BFD); and transmit an indication of the resources for the third reference signal to the UE.

Example 17 includes the subject matter of example 16, including or omitting optional elements, wherein the second reference signal and the third reference signal in each measurement timing window overlap in time.

Example 18 includes the subject matter of example 16, including or omitting optional elements, wherein the second reference signal and the third reference signal in each measurement timing window are non-overlapping in time.

Example 19 includes the subject matter of example 18, including or omitting optional elements, wherein the first reference signal, the second reference signal, and the third reference signal are separated by a guard period.

Example 20 is a method for a user equipment (UE), including processing a configuration of resources for a measurement timing window for measuring first reference signals for radio resource management (RRM) and a configuration of resources for second reference signals for either radio link monitoring (RLM) or beam failure detection (BFD). A first subset of the resources for the second reference signals are received within the measurement timing window and a second subset of the resources for the second reference signals are received outside the measurement timing window. The second reference signals are transmitted by a primary secondary cell (PSCell) of a secondary cell group (SCG). The method includes determining that the SCG is deactivated, and in response determining a status of an interruption alignment indicator. In response to the interruption alignment indicator being set, the method includes measuring subsequent second reference signals transmitted in the first subset of the resources for the second reference signals, and refraining from measuring subsequent second reference signals transmitted in the second subset of the resources for the second reference signals

Example 21 includes the subject matter of example 20, including or omitting optional elements, wherein the interruption alignment indicator includes an InterruptionAlignmentSCG flag in an SCG deactivation command.

Example 22 includes the subject matter of example 20, including or omitting optional elements, wherein the first reference signal and the second reference signal in each measurement timing window overlap in time.

Example 23 includes the subject matter of example 20, including or omitting optional elements, wherein the first reference signal and the second reference signal in each measurement timing window are non-overlapping in time.

Example 24 includes the subject matter of example 23, including or omitting optional elements, wherein the first reference signal and the second reference signal are separated by a guard period.

Example 25 is a method for a RAN including operations performed by the one or more processors of claims 10-19.

Example 26 is non-transitory computer-readable medium having executable instructions stored thereon that, when executed by a processor, cause the processor to perform operations performed by the one or more processors of claims 1-24.

Example 27 is an apparatus for a UE, comprising a radio frequency interface, a memory, and the one or more processors of claims 1-9.

Example 28 is a UE, comprising a radio frequency interface, a memory, and the one or more processors of claims 1-9.

Example 29 is an apparatus for a RAN node, comprising a radio frequency interface, a memory, and the one or more processors of claims 10-20.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A baseband processor, comprising a memory configured to store instructions; and one or more processors coupled to the memory and, when executing the instructions, configured to:
process a configuration of resources for a measurement timing window for measuring first reference signals for radio resource management (RRM);
process a configuration of second reference signal resources for either radio link monitoring (RLM) or beam failure detection (BFD), wherein a first subset of the second reference signal resources are received within the measurement timing window and a second subset of the second reference signal resources are received outside the measurement timing window, further wherein second reference signals are transmitted by a primary secondary cell (PSCell) of a secondary cell group (SCG); and
determine that the SCG is deactivated, and in response
determine a status of an interruption alignment indicator; and
in response to the interruption alignment indicator being set,
measure subsequent second reference signals transmitted in the first subset of the second reference signal resources, and
refrain from measuring subsequent second reference signals transmitted in the second subset of the second reference signal resources.

2. The baseband processor of claim 1, wherein the interruption alignment indicator comprises an InterruptionAlignmentSCG flag in an SCG deactivation command.

3. The baseband processor of claim 1, wherein a first reference signal and a second reference signal in each measurement timing window overlap in time.

4. The baseband processor of claim 1, wherein a first reference signal and a second reference signal in each measurement timing window are non-overlapping in time.

5. (canceled)

6. The baseband processor of claim 1, wherein the second reference signals are for RLM and wherein the one or more processors are configured to
process a configuration of third reference signal resources for beam failure detection (BFD), wherein a first subset of the the third reference signal resources are received within the measurement timing window and a second subset of the third reference signal resources are received outside the measurement timing window, further wherein third reference signals are transmitted by the PSCell; and
determine that the SCG is deactivated, and in response
determine a status of an interruption alignment indicator; and
in response to the interruption alignment indicator being set,
measure subsequent third reference signals transmitted in the first subset of the resources for the third reference signals, and
refrain from measuring subsequent third reference signals transmitted in the second subset of the resources for the third reference signals.

7. The baseband processor of claim 6, wherein a second reference signal and a third reference signal in each measurement timing window overlap in time.

8. The baseband processor of claim 6, wherein a second reference signal and a third reference signal in each measurement timing window are non-overlapping in time.

9. (canceled)

10. A baseband processor, comprising a memory configured to store instructions; and one or more processors coupled to the memory and, when executing the instructions, configured to:
cause transmission of and receive signals as a primary secondary cell (PSCell) for a secondary cell group (SCG);
determine a measurement timing window during which a user equipment (UE) measures first reference signals for radio resource management (RRM);
configure second reference signal resources, wherein a first subset of the second reference signal resources are received by the UE within with the measurement timing window and a second subset of the second reference signal resources are received by the UE outside the measurement timing window, wherein second reference signals are transmitted by the PSCell to the UE for radio link monitoring (RLM) or beam failure detection (BFD);
cause transmission of an indication of the second reference signal resources to the UE; and
cause transmission of an interruption alignment indicator to the UE that indicates to the UE that the resources for the first subset of the second reference signal resources are aligned with the measurement timing window.

11. The baseband processor of claim 10, wherein the one or more processors are configured to
configure the measurement timing window; and
cause transmission of an indication of the measurement timing window to the UE.

12. The baseband processor of claim 10, wherein the interruption alignment indicator comprises an InterruptionAlignmentSCG flag in an SCG deactivation command.

13. The baseband processor of claim 10, wherein the first reference signal and the second reference signal in each measurement timing window overlap in time.

14. The baseband processor of claim 10, wherein the first reference signal and the second reference signal in each measurement timing window are non-overlapping in time.

15. The baseband processor of claim 14, wherein the first reference signal and the second reference signal are separated by a guard period.

16. The baseband processor of claim 10, wherein the second reference signals are for RLM and wherein the one or more processors are configured to
configure third reference signal resources, wherein a first subset of the third reference signal resources are received by the UE within the measurement timing window and a second subset of the third reference signal resources are received by the UE outside the measurement timing window, wherein the third reference signals are transmitted by the PSCell for beam failure detection (BFD); and
cause transmission of an indication of the third reference signal resources to the UE.

17. The baseband processor of claim 16, wherein the second reference signal and the third reference signal in each measurement timing window overlap in time.

18. The baseband processor of claim 16, wherein the second reference signal and the third reference signal in each measurement timing window are non-overlapping in time.

19. (canceled)

20. A user equipment (UE), comprising radio frequency (RF) circuitry coupled to baseband circuitry, the baseband circuitry comprising memory and one or more processors configured to, when executing instructions stored in the memory, cause the UE to:
receive a configuration of resources for a measurement timing window for measuring first reference signals for radio resource management (RRM);
receive a configuration of resources for second reference signals for either radio link monitoring (RLM) or beam failure detection (BFD), wherein a first subset of the resources for the second reference signals are received within the measurement timing window and a second subset of the resources for the second reference signals are received outside the measurement timing window, further wherein the second reference signals are transmitted by a primary secondary cell (PSCell) of a secondary cell group (SCG); and
determine that the SCG is deactivated, and in response
determine a status of an interruption alignment indicator; and
in response to the interruption alignment indicator being set,
measure subsequent second reference signals transmitted in the first subset of the resources for the second reference signals, and
refrain from measuring subsequent second reference signals transmitted in the second subset of the resources for the second reference signals.

21. The UE of claim 20, wherein the interruption alignment indicator comprises an InterruptionAlignmentSCG flag in an SCG deactivation command.

22. (canceled)

23. The UE of claim 20, wherein the first reference signal and the second reference signal in each measurement timing window are non-overlapping in time.

24. The UE of claim 23, wherein the first reference signal and the second reference signal are separated by a guard period.
